(19) United States
(12) Patent Application Publication
(10) Pub. No.: US 2026/0112335 A1
(43) Pub. Date: Apr. 23, 2026

(54) INTEGRATED ARCHITECTURE

(71) Applicant: MEDIATEK INC., Hsinchu City (TW)

(72) Inventors: Kuo-Chen Huang, Hsinchu City (TW); Hsiang-Sheng Tsai, Hsinchu City (TW); Ming-Hsien Wu, Hsinchu City (TW)

(73) Assignee: MEDIATEK INC., Hsinchu City (TW)

(21) Appl. No.: 18/922,364

(22) Filed: Oct. 21, 2024

(51) Int. Cl. G09G 5/393

(52) U.S. Cl. CPC G09G 5/393; G09G 2360/128

(57) ABSTRACT

An integrated architecture includes an application processor adapted to acquire an unprocessed image, and apply an overdrive function and a frame rate conversion function for the unprocessed image to generate a processed image when a source frame rate and a panel frame rate are different. The integrated architecture of the present invention does not dispose the memory in the display drive integrated circuit, and the memory of the application processor which is cooperated with the foresaid ramlsss display drive integrated circuit can support both the overdrive function and the frame rate conversion function, so that the integrated architecture can have advantages of the preferred hardware cost, the preferred picture quality, the preferred power consumption and the preferred image control.

### BACKGROUND

A conventional display panel may have a drawback of the dragging problem, which means pixel values of the display panel cannot be changed immediately when the image frame of the display panel is varied, thereby causing content lags of the image frame. The common solution can use overdrive technology to provide a compensation value before change of the pixel value. The compensation value is increasing the voltage of a specific pixel, so that the specific pixel is rapidly adjusted to the target pixel value for reducing the response time. The overdrive technology is applied to the single image frame or multiple image frames. The conventional display panel has random access memory (RAMs) respectively installed on the application processor of the image source and the display drive integrated circuit (DDIC) of the display panel, which has disadvantages of high power consumption and high equipment cost.

### SUMMARY

The present invention provides an integrated architecture for solving above drawbacks.

According to the claimed invention, an integrated architecture includes an application processor adapted to acquire an unprocessed image, and apply an overdrive function and a frame rate conversion function for the unprocessed image to generate a processed image when a source frame rate and a panel frame rate are different.

According to the claimed invention, the integrated architecture further includes a ramless display drive integrated circuit electrically connected with the application processor, the application processor transmits the processed image to the ramless display drive integrated circuit and directly forwards the processed image to a display panel.

According to the claimed invention, the application processor is adapted to simultaneously apply the overdrive function and the frame rate conversion function for the unprocessed image; or, the application processor is adapted to apply the frame rate conversion function for the unprocessed image, and then apply the overdrive function for the unprocessed image.

According to the claimed invention, the source frame rate is lower than the panel frame rate, the application processor utilizes the frame rate conversion function to convert the unprocessed image with the source frame rate into the processed image with the panel frame rate.

According to the claimed invention, the application processor includes a memory, and the memory may be a dynamic random access memory or a static random access memory. The memory is adapted to store a previous image having a generation point of time earlier than a generation point of time of the unprocessed image for the overdrive function; or, the memory is adapted to store a plurality of previous images having generation points of time earlier than a generation point of time of the unprocessed image for the overdrive function.

According to the claimed invention, the application processor includes a processing module and an updated module, the processing module is adapted to apply the overdrive function for the unprocessed image and the plurality of previous images, and the updated module is adapted to utilize the unprocessed image and the plurality of previous images to further update the plurality of previous images inside the memory.

According to the claimed invention, when the source frame rate and the panel frame rate are the same, the application processor is adapted to only apply the overdrive function for the unprocessed image to generate the processed image.

According to the claimed invention, an integrated architecture includes an application processor and a ramless display drive integrated circuit. The application processor is adapted to acquire an unprocessed image. The ramless display drive integrated circuit is electrically connected with the application processor, and adapted to output a processed image with an overdrive effect and having a frame rate different from a frame rate of the unprocessed image.

The integrated architecture of the present invention does not dispose the memory in the display drive integrated circuit, and the memory of the application processor which is cooperated with the foresaid ramlsss display drive integrated circuit can support both the overdrive function and the frame rate conversion function, so that the integrated architecture can have advantages of the preferred hardware cost, the preferred picture quality, the preferred power consumption and the preferred image control.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an integrated architecture according to a first embodiment of the present invention.

FIG. 2 is a functional block diagram of an integrated architecture according to a second embodiment of the present invention.

### DETAILED DESCRIPTION

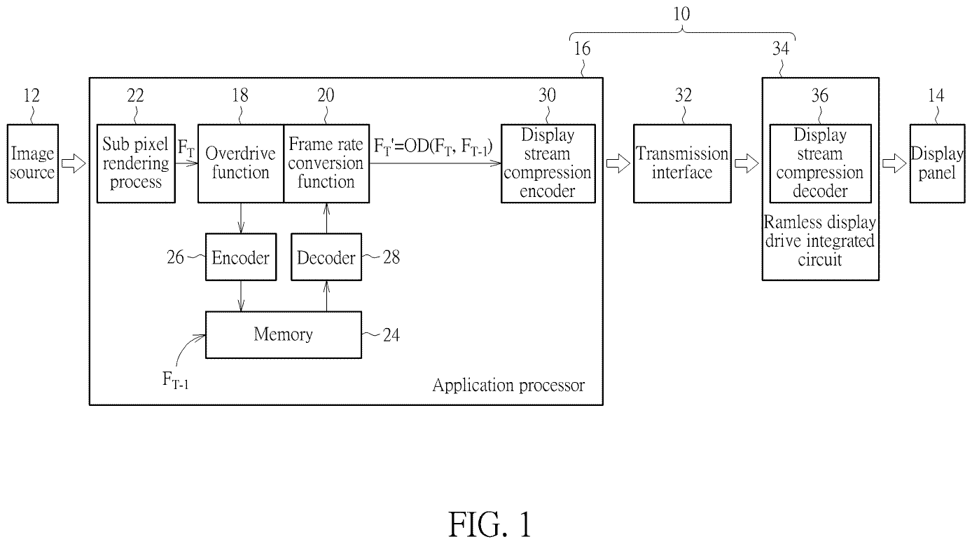

Please refer to FIG. 1. FIG. 1 is a functional block diagram of an integrated architecture 10 according to a first embodiment of the present invention. The integrated architecture 10 can be applied between an image source 12 and a display panel 14, and used to increase displaying efficiency of the display panel 14 via improvement of overdrive process. The integrated architecture 10 can include an application processor 16. In the broadest definition of the first embodiment, the application processor 16 can acquire unprocessed image from the image source 12, and can further apply an overdrive function 18 and a frame rate conversion function 20 for the unprocessed image to generate a processed image when a source frame rate of the image source 12 is different from a panel frame rate of the display panel 14.

In the present invention, the application processor 16 of the integrated architecture 10 can simultaneously support both the overdrive function 18 and the frame rate conversion function 20, which means the frame rate conversion function 20 is not executed by a display drive integrated circuit (DDIC), and the application processor 16 can be cooperated with the display drive integrated circuit without a random access memory (RAM) to form the integrated architecture 10. The application processor 16 can preferably execute the overdrive function 18 when the source frame rate and the panel frame rate are converted into the same frame rate by the frame rate conversion function 20, and therefore the integrated architecture 10 of the present invention can effectively prevent the dragging problem.

The application processor 16 can usually execute the frame rate conversion function 20 and then the overdrive function 18, or can simultaneously execute the overdrive function 18 and the frame rate conversion function 20, so that the overdrive function 18 can be executed based on the panel frame rate for the preferred efficiency and an aim of preventing the dragging problem; that is to say, the application processor 16 does not execute the overdrive function 18 and then the frame rate conversion function 20 due to the overdrive function 18 in this situation is executed based on the source frame rate instead of the panel frame rate.

The integrated architecture 10 of the present invention does not use the display drive integrated circuit with the random access memory; instead, functions originally executed by the random access memory of the display drive integrated circuit are integrated into the application processor 16. The application processor 16 can have multiple purposes, such as supporting both the overdrive function 18 and the frame rate conversion function 20, and the integrated architecture 10 of the present invention can have preferred hardware cost (for example, the application processor 16 is cooperated with the display drive integrated circuit without the random access memory), preferred picture quality (for example, the overdrive function 18 is executed based on the panel frame rate), preferred power consumption (for example, only the application processor 16 generates computation power of the random access memory), and preferred image control (for example, the image is directly sourced from the application processor 16 because the display drive integrated circuit without the random access memory is applied to the display panel 14.

The application processor 16 may be optionally applied by sub pixel rendering process 22 which can decrease a number of sub-pixels and increase pixel arrangement space, so that the application processor 16 can be applied for the display panel 14 with high resolution, and have advantages of high penetration rate and preferred process yield and low power consumption. The application processor 16 may include a memory (for example, a random access memory 24 or any other type of memory), and the random access memory 24 can be a dynamic random access memory or a static random access memory, and used to store one or a plurality of previous images having a generation point of time earlier than a generation point of time of the unprocessed image for the overdrive function 18.

The application processor 16 may further include an encoder 26, a decoder 28 and a display stream compression encoder 30. The one or a plurality of previous images can be encoded by the encoder 26 and transmitted to the random access memory 24 for storage, and the encoded one or a plurality of previous images can be further decoded by the decoder 28 and transmitted from the random access memory 24 to the overdrive function 18 and/or the frame rate conversion function 20 for generating the processed image. The processed image can be encoded by the display stream compression encoder 30 and transmitted to the display panel 14 via a transmission interface 32 (such as mobile industry processor interface, MIPI) and a ramless display drive integrated circuit 34.

The ramless display drive integrated circuit 34 may be a part of the display panel 14, and can include a display stream compression decoder 36 used to decode the encoded processed image from the transmission interface 32, and then transmit the decoded processed image towards the display panel 14. The ramless display drive integrated circuit 34 can be electrically connected with the application processor 16, and can directly transmit the processed image from the application processor 16 forwards the display panel 14.

In the first embodiment, the source frame rate of the image source 12 can be preferably lower than the panel frame rate of the display panel 14, and the application processor 16 can utilize the frame rate conversion function 20 to convert the unprocessed image with the source frame rate into the processed image with the panel frame rate. It should be mentioned that the application processor 16 may simultaneously apply the overdrive function 18 and the frame rate conversion function 20 for the unprocessed image, or may apply the frame rate conversion function 20 for the unprocessed image and later apply the overdrive function 18 for the unprocessed image.

In other possible situation, the source frame rate of the image source 12 may be the same as the panel frame rate of the display panel 14, and the application processor 16 can only apply the overdrive function 18 for the unprocessed image to generate the processed image without execution of the frame rate conversion function 20.

In a second embodiment of the present invention, the integrated architecture 10 can include the application processor 16 and the ramless display drive integrated circuit 34; the application processor 16 can acquire the unprocessed image for execution of the overdrive function 18 and the frame rate conversion function 20, and the ramless display drive integrated circuit 34 can have a function of outputting the processed image with an overdrive effect (which is applied by the overdrive function 18 of the application processor 16) and having a frame rate the same as or different from the source frame rate but the same as the panel frame rate (which is applied by the frame rate conversion function 20 of the application processor 16) towards the display panel 14.

The integrated architecture 10 shown in FIG. 1 can be applied to the one shot overdrive process. The random access memory 24 can store the previous image having the generation point of time earlier than the generation point of time of the unprocessed image. For example, the sub pixel rendering process 22 outputs the current image F_{T}, and the random access memory 24 stores the previous image F_{T-1}, so the overdrive function 18 can execute the one shot overdrive process F_{T}′ by the current image F_{T} of the sub pixel rendering process 22 and the previous image F_{T-1} of the random access memory 24; practical application of the one shot overdrive process is not limited to the foresaid embodiment.

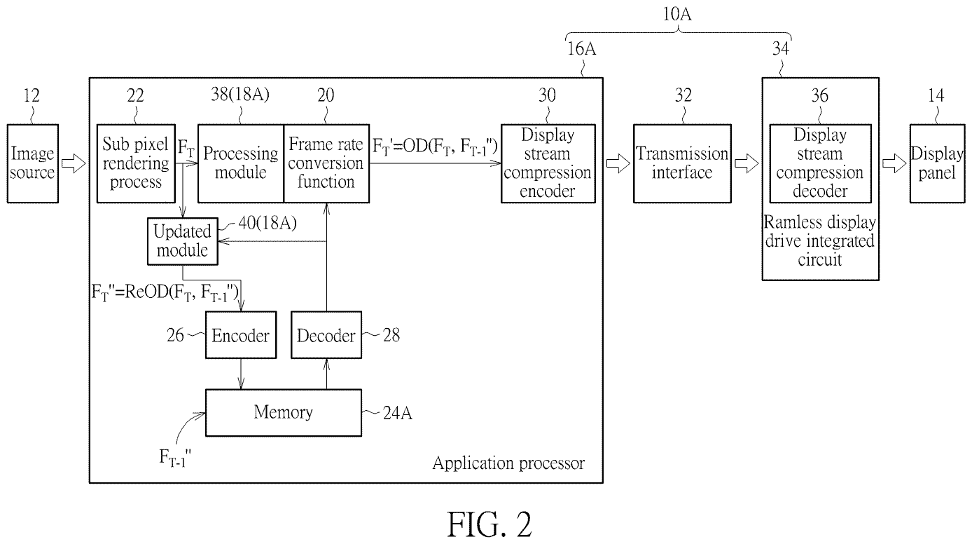

Please refer to FIG. 2. FIG. 2 is a functional block diagram of an integrated architecture 10A according to a second embodiment of the present invention. In the second embodiment, elements having the same numerals as ones of the first embodiment have the same structures and functions, and a detailed description is omitted herein for simplicity. The memory (such as the random access memory 24A) of the integrated architecture 10A can store the plurality of previous images having generation points of time earlier than the generation point of time of the unprocessed image. The overdrive function 18A of the application processor 16A can include a processing module 38 and an updated module 40. The random access memory 24A can have the multiple previous images F_{T-1}″ set as historical data. The processing module 38 can apply the recursive overdrive process F_{T}′ for the current image F_{T} and the multiple previous images F_{T-1}″. The updated module 40 can execute image update F_{T}″ in the random access memory 24A by the current image F_{T} and the multiple previous images F_{T-1}″ for the recursive effect.

The frame rate conversion function can be a self-refresh function, which can provide refresh control at certain intervals and be usually used in the power saving mode or the sleep mode, for preferred reduction of power consumption. In order to save power, the self-refresh period of the self-refresh function may be usually lengthened; however, longer self-refresh period may lead to display error due to regression of the voltage corresponding to the pixels on the panel. Therefore, some possible embodiments of the present invention can receive or retrieve the raw frame from the image source 12, and the last frame or the frame history from the random access memory 24 (or 24A), and the one shot overdrive process or the recursive overdrive process can be applied to send the result out and store related information into the random access memory 24 (or 24A); meanwhile, the panel frame rate can be a multiple of the source frame rate, and new frame can come in the application processor 16 (or 16A) when the panel frame rate and the source frame rate simultaneously output the frame, or the self-refresh function can be executed when the source frame rate does not output the frame. In other possible embodiments of the present invention, the application processor 16 (or 16A) may read the last frame or the frame history out from the random access memory 24 (or 24A), and then bypass the one shot overdrive process or the recursive overdrive process to directly send the result towards the ramless display drive integrated circuit 34, which executes the self-refresh function when the source frame rate does not output the frame.

In conclusion, the integrated architecture of the present invention does not dispose the memory in the display drive integrated circuit, and the memory of the application processor which is cooperated with the foresaid ramlsss display drive integrated circuit can support both the overdrive function and the frame rate conversion function, so that the integrated architecture can have advantages of the preferred hardware cost, the preferred picture quality, the preferred power consumption and the preferred image control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated architecture, comprising:
an application processor adapted to acquire an unprocessed image, and apply an overdrive function and a frame rate conversion function for the unprocessed image to generate a processed image when a source frame rate and a panel frame rate are different.

2. The integrated architecture of claim 1, wherein the integrated architecture further comprises a ramless display drive integrated circuit electrically connected with the application processor, the application processor transmits the processed image to the ramless display drive integrated circuit and directly forwards the processed image to a display panel.

3. The integrated architecture of claim 1, wherein the application processor is adapted to simultaneously apply the overdrive function and the frame rate conversion function for the unprocessed image.

4. The integrated architecture of claim 1, wherein the application processor is adapted to apply the frame rate conversion function for the unprocessed image, and then apply the overdrive function for the unprocessed image.

5. The integrated architecture of claim 1, wherein the source frame rate is lower than the panel frame rate, the application processor utilizes the frame rate conversion function to convert the unprocessed image with the source frame rate into the processed image with the panel frame rate.

6. The integrated architecture of claim 1, wherein the application processor comprises a memory, and the memory is a dynamic random access memory or a static random access memory.

7. The integrated architecture of claim 1, further comprising:
a memory adapted to store a previous image having a generation point of time earlier than a generation point of time of the unprocessed image for the overdrive function.

8. The integrated architecture of claim 1, further comprising:
a memory adapted to store a plurality of previous images having generation points of time earlier than a generation point of time of the unprocessed image for the overdrive function.

9. The integrated architecture of claim 8, wherein the application processor comprises a processing module and an updated module, the processing module is adapted to apply the overdrive function for the unprocessed image and the plurality of previous images, and the updated module is adapted to utilize the unprocessed image and the plurality of previous images to further update the plurality of previous images inside the memory.

10. The integrated architecture of claim 1, wherein when the source frame rate and the panel frame rate are the same, the application processor is adapted to only apply the overdrive function for the unprocessed image to generate the processed image.

11. An integrated architecture, comprising:
an application processor adapted to acquire an unprocessed image; and
a ramless display drive integrated circuit electrically connected with the application processor, and adapted to output a processed image with an overdrive effect and having a frame rate different from a frame rate of the unprocessed image.

12. The integrated architecture of claim 11, wherein the application processor is adapted to further apply an overdrive function and a frame rate conversion function for the unprocessed image to generate the processed image when a source frame rate and a panel frame rate are different.

13. The integrated architecture of claim 12, wherein the application processor is adapted to simultaneously apply the overdrive function and the frame rate conversion function for the unprocessed image.

14. The integrated architecture of claim 12, wherein the application processor is adapted to apply the frame rate conversion function for the unprocessed image, and then apply the overdrive function for the unprocessed image.

15. The integrated architecture of claim 12, wherein the source frame rate is lower than the panel frame rate, the application processor utilizes the frame rate conversion function to convert the unprocessed image with the source frame rate into the processed image with the panel frame rate.

16. The integrated architecture of claim 12, wherein the application processor comprises a memory, and the memory is a dynamic random access memory or a static random access memory.

17. The integrated architecture of claim 12, wherein the application processor comprises a memory adapted to store a previous image having a generation point of time earlier than a generation point of time of the unprocessed image for the overdrive function.

18. The integrated architecture of claim 12, wherein the application processor comprises a memory adapted to store a plurality of previous images having generation points of time earlier than a generation point of time of the unprocessed image for the overdrive function.

19. The integrated architecture of claim 18, wherein the application processor further comprises a processing module and an updated module, the processing module is adapted to apply the overdrive function for the unprocessed image and the plurality of previous images, and the updated module is adapted to utilize the unprocessed image and the plurality of previous images to further update the plurality of previous images inside the memory.

20. The integrated architecture of claim 12, wherein when the source frame rate and the panel frame rate are the same, the application processor is adapted to only apply the overdrive function for the unprocessed image to generate the processed image.
